(19) United States
(12) Patent Application Publication
(10) Pub. No.: US 2007/0039295 A1
(43) Pub. Date: Feb. 22, 2007

(54) Exhaust gas cleanup system

(75) Inventor: Kazushige Ohno, Gifu (JP)

Correspondence Address: FINNEGAN, HENDERSON, FARABOW, GARRETT & DUNNER;LLP, 901 NEW YORK AVENUE, NW, WASHINGTON, DC, 20001-4413, US

(73) Assignee: IBIDEN CO., LTD.

(21) Appl. No.: 11/414,361

(22) Filed: May 1, 2006

Related U.S. Application Data
(63) Continuation of application No. PCT/JP05/15551, filed on Aug. 26, 2005.

(30) Foreign Application Priority Data
Aug. 31, 2004 (JP) 2004-252889

(51) Int. Cl. B01D 46/00

(52) U.S. Cl. 55/482; 55/523

(57) ABSTRACT

An exhaust gas cleanup system 10 includes a honeycomb filter 30 disposed at a position of an exhaust path length of about 1 m or less from the engine 20 (length from the extreme upstream portion of a manifold 22 to the front end of the honeycomb filter 30), and a honeycomb structure 40 disposed at a position of an exhaust path length of about 3 m or less from the engine 20.

### CROSS-REFERENCE TO RELATED APPLICATIONS

The present invention is a continuation of International Application No PCT/JP2005/015551, filed on Aug. 26, 2005 and now abandoned, which claims priority from Japanese Patent Application No. 2004-252889 filed on Aug. 31, 2004.

### BACKGROUND ART

1. Field of the Invention

The present invention relates to an exhaust gas cleanup system.

2. Description of the Prior Art

Conventionally, as an exhaust gas cleanup system, one has been proposed which includes a support that supports an NOx storage agent (barium, etc.) and an oxidation catalyst (platinum, etc.) disposed on the upstream of exhaust gas flow and a diesel particulate filter (hereinafter, referred to as DPF) supporting an oxidation catalyst (platinum, etc.) disposed on the downstream. For example, the apparatus disclosed in JP-A 2002-153733 regenerates the DPF by burning, at low temperature, particulate materials trapped by the DPF disposed on the downstream by using NO₂ produced by oxidizing NOx stored in the NOx storage agent, and converts NOx, HC, and CO contained in the exhaust gas by using the oxidation catalyst supported on the DPF. The contents of JP-A 2002-153733 are incorporated by reference herein.

### SUMMARY OF THE INVENTION

The exhaust gas cleanup system of the invention cleans an exhaust gas exhausted from an internal combustion engine, including: a first cleanup apparatus that supports a predetermined supporting amount of a first catalyst and purifies particulate materials in the exhaust gas; and a second cleanup apparatus that supports a predetermined supporting amount of a second catalyst and converts the exhaust gas which has passed through the downstream of the first cleanup apparatus, wherein the first cleanup apparatus is disposed at a position of an exhaust path length of about 1 m or less from the internal combustion engine.

In this exhaust gas cleanup system, the first cleanup apparatus is disposed at a position of an exhaust path length of about 1 m or less from the internal combustion engine, so that the exhaust gas reaches the first cleanup apparatus while keeping a high temperature without great heat removal by the exhaust path (for example, exhaust pipe, or the like). As a result, the first catalyst supported by the first cleanup apparatus is quickly raised in temperature by the exhaust gas to sufficiently perform its catalyst function, so that trapped particulate materials are easily burned. On the downstream of the first cleanup apparatus, the second cleanup apparatus that converts the exhaust gas is disposed, so that harmful substances (NOx, HC, CO, and so on) produced due to combustion of the internal combustion engine and harmful substances (CO, etc.) produced due to imperfect combustion of a part of the particulate materials trapped in the first cleanup apparatus can be converted. Therefore, the first cleanup apparatus can be easily regenerated and a plurality of harmful substances can be converted. Herein, “exhaust path length from the internal combustion engine” means the length from the extreme upstream portion of exhaust gas flow to the front end of the first cleanup apparatus. Also, “predetermined supporting amount” may be defined as a supporting amount that sufficiently purifies/converts the harmful substances contained in the exhaust gas.

In the exhaust gas cleanup system of the invention, the first cleanup apparatus preferably has a porosity of about 60% or more, more preferably about 75% or more, and most preferably about 80% or more. The porosity of about 60% or more preferably allows efficient burning of particulate materials since the particulate materials trapped in the first cleanup apparatus easily come into contact with the first catalyst supported by the first cleanup apparatus. The first cleanup apparatus preferably has a porosity of about 95% or less. The porosity of about 95% or less preferably prevents the material forming the wall of the first cleanup apparatus from being reduced, thus keeping the strength of the first cleanup apparatus.

In the exhaust gas cleanup system of the invention, the first cleanup apparatus may be a honeycomb filter including lamination in the longitudinal direction of two or more sheet-like members with a plurality of through holes so as to communicate the through holes with each other to form communicating holes. Thereby, even when a temperature difference occurs in the longitudinal direction of the first cleanup apparatus due to combustion heat of the particulate materials and a heat stress is applied, the stress is reduced between the lamination of the sheet-like members, so that damage due to the heat stress is less likely to occur than in the case of integral molding in the longitudinal direction. In the honeycomb filter, the end faces of the plurality of through holes may be alternately clogged.

In the exhaust gas cleanup system of the invention, the honeycomb filter may be mainly made of one or more kinds selected among inorganic fibers and inorganic foams. Thereby, a filter with a porosity of about 60% or more (in particular, about 75% or more) can be comparatively easily realized by using the inorganic fibers and inorganic foams. The inorganic fibers may be, for example, metal fibers or ceramic fibers. Examples of metal fibers include fibers of one or more kinds selected among copper, iron (chromium-based stainless steel, chrome-nickel-based stainless steel, etc.), aluminum, and examples of ceramic fibers includes fibers of one or more kinds selected among oxide-based fibers such as alumina, silica, silica-alumina, and potassium titanate, and carbide-based fibers such as silicon carbide. The inorganic foams may be, for example, metal foams or ceramic foams, and metal foams are preferable since they have high strength. Examples of metal foams include foams of one or more kinds selected among copper, iron (chromium-based stainless steel, chrome-nickel-based stainless steel, etc.), and aluminum, and examples of ceramic foams include foams of one or more kinds selected among cordierite, alumina, mullite, silica, silicon carbide, and aluminum titanate.

In the exhaust gas cleanup system of the invention, the second cleanup apparatus may be disposed at a position of an exhaust path length of about 3 m or less from the internal combustion engine. Thereby, the exhaust gas reaches the second cleanup apparatus without great heat removal by the exhaust path (for example, an exhaust pipe), so that the second catalyst supported by the second cleanup apparatus is made to function by using the exhaust gas heat, and a plurality of harmful substances contained in the exhaust gas are easily converted.

In the exhaust gas cleanup system of the invention, the second cleanup apparatus may be a honeycomb structure including a porous honeycomb unit that have a plurality of through holes and have a sectional area of about 50 cm² or less orthogonal to the through holes, and a sealing material layer that joins two or more of the porous honeycomb units on their outer faces with no through holes being open. Thereby, the plurality of porous honeycomb units are structured so as to be joined to each other via a sealing material layer, so that strength against thermal shock or vibrations can be increased. When the area of the section orthogonal to the through holes is about 50 cm² or less, the size of the honeycomb unit does not become excessively large and a heat stress applied to each honeycomb unit is sufficiently reduced. In addition, the sectional area of the plane orthogonal to the through holes is preferably about 5 cm² or more. The sectional area of about 5 cm² or more is preferable since the sectional area of the sealing material layer that joins a plurality of porous honeycomb units does not become relatively large and the specific surface area to support the catalyst does not become relatively small, thus preventing the pressure loss from being increased. Herein, the sectional area of the porous honeycomb unit means the sectional area of the porous honeycomb unit as a basic unit forming the honeycomb structure when the honeycomb structure includes a plurality of porous honeycomb units with different sectional areas, and is normally the maximum sectional area of the porous honeycomb unit. In addition, the total sectional area of the porous honeycomb units preferably occupies about 85% or more of the sectional area of the honeycomb structure, and more preferably, occupies about 90% or more. When the total sectional area of about 85% or more, the percentage of the total sectional area is the sealing material layer to the sectional area of the honeycomb structure does not become relatively high, the total sectional area of the porous honeycomb units is not excessively reduced, so that the specific surface area supporting the catalyst does not become relatively small and the pressure loss does not increase.

In the exhaust gas cleanup system of the invention, the porous honeycomb unit may contain at least ceramic particles and inorganic fibers. Thereby, a honeycomb structure that highly disperses the catalyst and has increased strength against thermal shock and vibrations can be comparatively easily realized. Herein, examples of ceramic particles include particles of one or more kinds selected among alumina, silica, zirconia, titania, ceria, and mullite, and among these, alumina is preferable. As inorganic fibers contained in the honeycomb structure, the inorganic fibers explained in the honeycomb filter may be used, and among these, silica-alumina fibers are preferable. The honeycomb structure may further include inorganic binders as material. Thereby, sufficient strength is obtained even after firing at a comparatively low temperature. The inorganic binders to be contained in the honeycomb structure may be, for example, inorganic sols or clay-based binders. Examples of inorganic sols include one or more kinds of inorganic sols selected among alumina sol, silica sol, titania sol, water glass, and so on are available. Examples of clay-based binders include one or more kinds of clay-based binders selected among white clay, kaolin, montmorillonite, and clays with chain structures (sepiolite, attapulgite). Among these, silica sol is preferable as an inorganic binder.

In the exhaust gas cleanup system of the invention, the first catalyst supported by the first cleanup apparatus is preferably an oxidation catalyst that lowers combustion energy of particulate materials, and may be, for example, one or more kinds of oxidation catalysts selected among precious metals, and oxides. Example of precious metals include one or more kinds selected among platinum, palladium, rhodium, and examples of oxides includes CeO₂ and oxides with a perovskite structures. Among these, an oxide with a perovskite structure is preferable. Precious metals such as platinum to be used as a catalyst are very expensive, and are limited precious resources. Therefore, it is preferable that these are used as little as possible. An oxide having a perovskite structure is, for example, an oxide using one or more elements selected among La, Y, Ce, and so on for the A site of the perovskite structure (general formula: ABO₃), where La is preferable among these elements, and using one or more elements selected among Fe, Co, Ni, Mn, and so on for the B site of the general formula. In addition, a part of the elements of the A site may be substituted by K, Sr, Ag, and so on, such as La_{0.75}K_{0.25}CoO₃.

In the exhaust gas cleanup system of the invention, the second catalyst supported by the second cleanup apparatus is preferably an oxidation catalyst and an NOx storage agent which can convert harmful substances (NOx, CO, HC, and so on) contained in the exhaust gas. The oxidation catalyst may be, for example, precious metals, and the NOx storage agent may contain, for example, one or more kinds selected from a group consisting of alkali metals and alkaline earth metals. Herein, examples of precious metals include one or more kinds selected among platinum, palladium, and rhodium, and examples of alkali metals include one or more kinds selected from potassium, sodium, and examples of alkaline earth metals include barium.

The physical properties used in this specification were determined as follows. The average diameter of the inorganic fibers was determined by using an SEM with reference to JIS A9504. The contents of JIS A9504 are incorporated by reference herein. The length of the inorganic fibers was also determined by using an SEM. An optical microscope or laser microscope may instead be used. The average diameter of γ-alumina and α-type silicon carbide particles was determined by a laser diffraction scattering method by using a Mastersizer Micro made by MALVERN.

### BRIEF DESCRIPTION OF THE DRAWINGS

FIG. 1 is a drawing showing the outline of the construction of an exhaust gas cleanup system 10 of an embodiment;

FIG. 2 is an explanatory view of a honeycomb filter 30 of the embodiment;

FIG. 3 is an explanatory view of a honeycomb filter 30 of the embodiment;

FIG. 4 is an explanatory view of a honeycomb structure 40 of the embodiment;

FIG. 5 is a schematic view of purification of particulate materials by the honeycomb filter of the embodiment;

FIG. 6 is a schematic view of conversion of harmful substances by the honeycomb structure of the embodiment;

FIG. 7 is a drawing showing the outline of the construction of an exhaust gas cleanup system 50 of another embodiment;

FIG. 8 is an explanatory view of a honeycomb filter 130 of another embodiment;

FIG. 9 is an explanatory view of a honeycomb structure 140 of another embodiment;

FIG. 10 is an explanatory view of an exhaust gas cleanup measuring device 60; and

FIG. 11 is an explanatory view of measuring conditions of a 10-15 mode exhaust gas measuring test.

### DETAILED DESCRIPTION OF THE INVENTION

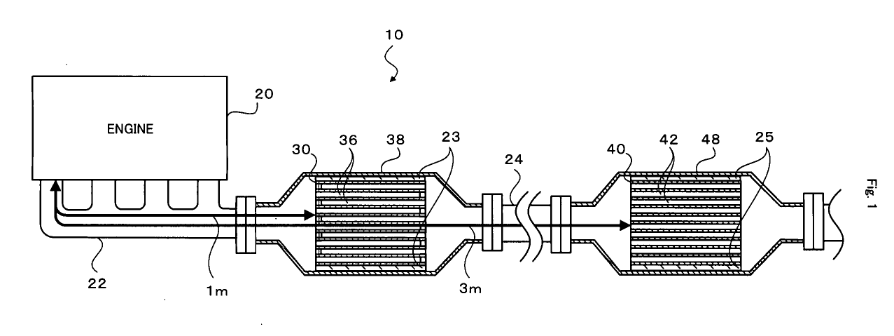

Next, a best mode for carrying out the invention is described with reference to the drawings. FIG. 1 is a schematic view of the construction of an exhaust gas cleanup system 10 of this embodiment. The exhaust gas cleanup system 10 includes a manifold 22 connected to an engine 20, through which an exhaust gas produced by burning a fuel flows, a first casing 38 connected to the manifold 22, a honeycomb filter 30 as a first cleanup apparatus that supports a first catalyst and is retained via an alumina mat 23 inside the first casing 38, an exhaust pipe 24 connected to the first casing 38, through which an exhaust gas flows, a second casing 48 connected to the exhaust pipe 24, and a honeycomb structure 40 as a second cleanup apparatus which supports a second catalyst and is retained via an alumina mat 25 inside the second casing 48. The exhaust gas cleanup system 10 is mounted in a vehicle (automobile). In this exhaust gas cleanup system 10, the honeycomb filter 30 is disposed at a position of, as shown in FIG. 1, an exhaust path length of about 1 m or less from the engine 20, that is, an exhaust path length of about 1 m or less from the extreme upstream portion of the manifold 22 through which an exhaust gas flows to the front end of the honeycomb filter 30. The honeycomb structure 40 is disposed at a position of an exhaust path length of about 3 m or less from the extreme upstream portion of the manifold 22 through which the exhaust gas flows to the front end of the honeycomb structure 40.

The engine 20 is constructed as a diesel engine (internal combustion engine) that generates a driving force by burning a hydrocarbon-based fuel such as light oil by fuel injection into air compressed by a piston. The exhaust gas from the engine 20 contains nitrogen oxide (NOx), hydrocarbon (HC), carbon monoxide (CO), and particulate materials (hereinafter, referred to as PM) produced from carbon or the like contained in the fuel.

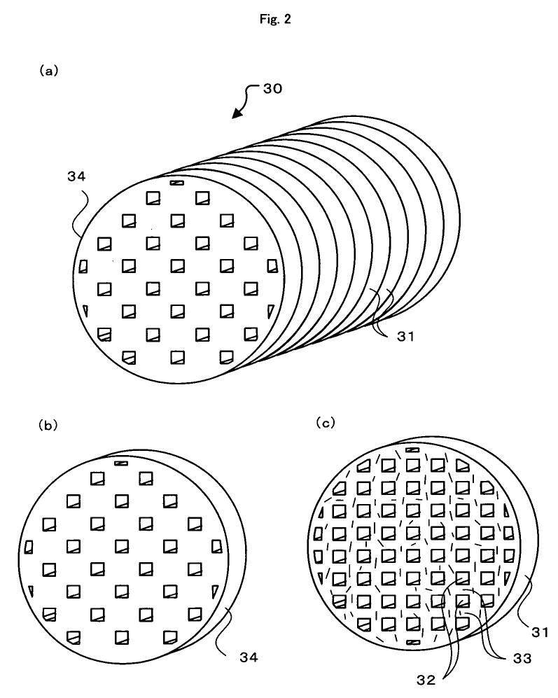

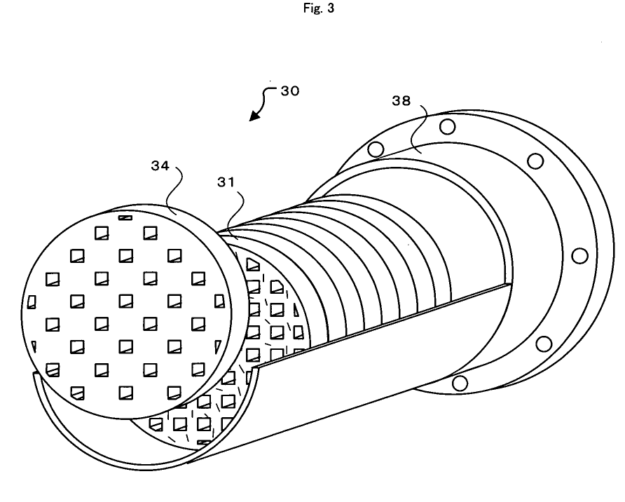

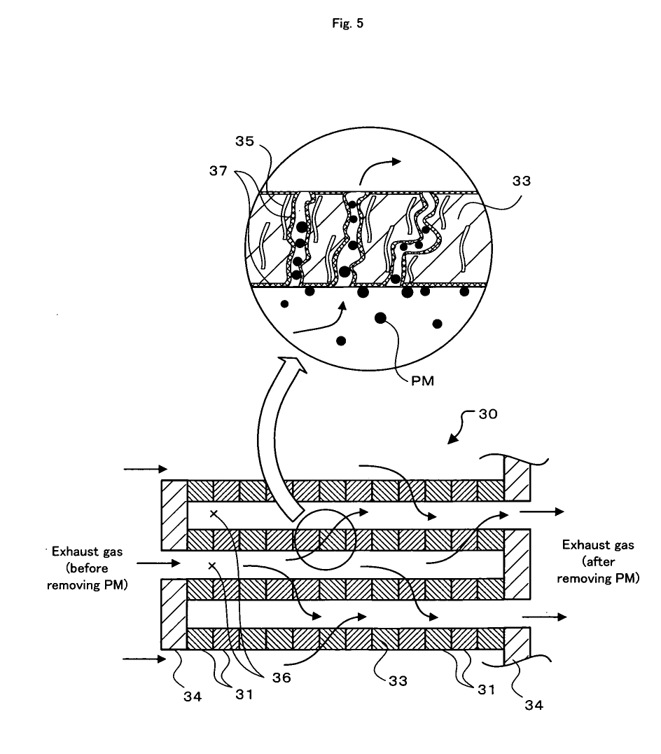

The honeycomb filter 30 is a filter for removing PM contained in the exhaust gas of the engine 20. FIG. 2 is an explanatory view of the honeycomb filter 30, wherein (a) is a perspective view of the honeycomb filter 30, (b) is a perspective view of an end portion sheet-like member 34, and (c) is a perspective view of a sheet-like member 31, and FIG. 3 is an explanatory view of the honeycomb filter 30 and the first casing 38. The honeycomb filter 30 is formed by laminating, in the longitudinal direction, two or more disk-shaped inorganic fiber-made sheet-like members 31 having a plurality of through holes 32 so that the through holes 32 communicate with each other to form communicating holes 36 (see FIG. 5). On both ends of the honeycomb filter 30, metal-made end portion sheet-like members 34 are disposed, and a pressure is applied in this lamination direction to fix the filter inside the first casing 38. In the honeycomb filter 30, The plurality of the communicating holes 36 are arranged side by side along the longitudinal direction, and end faces of the communicating holes 36 are alternately clogged. Therefore, the exhaust gas flows into the communicating holes 36 the upstream sides of which are open in the honeycomb filter 30, and then passes through the wall part 33 and moves to the communicating holes 36 the downstream side of which is open, and flows out from the honeycomb filter 30 through the communicating holes 36. In this course, PM contained in the exhaust gas is trapped when it passes through the wall part 33. A greater amount of heat or pressure caused by the exhaust gas may be applied to the end faces of the honeycomb filter 30 than to the inner face of the honeycomb filter 30, however, the end portion sheet-like members 34 are made of metal, so that the honeycomb filter 30 can be prevented from being damaged. The thicknesses of the sheet-like members 31 and the end portion sheet-like members 34 are preferably in a range of about 0.1 to about 20 mm. One end portion sheet-like member 34 may be disposed each on both ends of the lamination of the sheet-like members 31, or several end portion sheet-like members may be disposed. Herein, the end portion sheet-like members 34 are made of metal, however, they may be made of any material such as the same material as the sheet-like members 31 or materials that can be used for the sheet-like members 31 (various materials described later). In this case, it is preferable that the end portion sheet-like members 34 have strength higher than that of the sheet-like members 31. Particularly, when the sheet-like members 31 are made of metal, the honeycomb filter 30 is easily prevented from being damaged even in use under bad conditions.

The honeycomb filter 30 is formed to have a porosity of about 75 to about 95%. In this range, the filter efficiently burns PM and obtains sufficient strength. The apparent density of the honeycomb filter 30 is preferably about 0.5 to about 1.00 g/cm³, and more preferably about 0.10 to about 0.50 g/cm³.

The sectional area of the through hole 32 formed in the honeycomb filter 30 is preferably about 1.4 mm×1.4 mm to about 16 mm×16 mm. The thickness (wall thickness) of the wall part 33 between the through holes 32 is preferably in the range of about 0.2 to about 10.0 mm, and more preferably, about 0.3 to about 6.0 mm. When the wall thickness is about 0.2 mm or more, PM leakage can be prevented and trapping efficiency is not lowered, and when it is about 10.0 mm or less, the exhaust gas easily passes through the wall part 33 and the pressure loss does not increase. The number of through holes 32 per unit sectional area (cell density) is preferably about 0.16 to about 62/cm² (about 1.0 to about 400 cpsi), and more preferably about 0.62 to about 31/cm² (about 4 to about 200 cpsi). When the number of through holes is about 0.16/cm² or more, the area of the wall to come into contact with the exhaust gas inside the honeycomb filter 30 becomes large, and when the number is about 62/cm² or less, the pressure loss does not easily increase and manufacturing of the honeycomb filter 30 does not become difficult. The shape of the through holes 32 may be rectangular, triangular, or hexagonal.

The sheet-like member 31 of the honeycomb filter 30 is mainly made of inorganic fibers. The inorganic fibers may be, for example, metal fibers, ceramic fibers, and so on are available. Examples of metal fibers include fibers of one or more kinds selected among copper, iron (chromium-based stainless steel, chrome-nickel-based stainless steel, etc.), aluminum, and examples of ceramic fibers include fibers of one or more kinds selected among oxide-based fibers such as alumina, silica, silica-alumina, and potassium titanate, etc., nitride-based fibers of aluminum nitride, silicon nitride, boron nitride, and titanium nitride, etc., carbide-based fibers such as silicon carbide, etc. The length of the inorganic fibers is preferably about 0.1 to about 300 μm, and more preferably about 0.5 to about 50 μm. The diameter of the inorganic fibers is preferably about 1 to about 30 μm, and more preferably about 2 to about 10 μm. The sheet-like member 31 contains an inorganic binder that binds the inorganic fibers. The inorganic binder may be, for example, one or more kinds of binders selected among inorganic glass such as silicate glass, silicate alkali glass, and boron silicate glass, etc., and sol such as alumina sol, silica sol, and titania sol, etc. The content of the inorganic binder in the honeycomb filter 30 is preferably about 5 to about 50 weight percent as a solid content in the honeycomb filter 30, and more preferably about 10 to about 40 weight percent. When the content of the binder is about 5 weight percent or more, the strength of the honeycomb filter 30 is not easily lowered, and when the content of the binder is about 50 weight percent or less, a high porosity is easily realized.

Many inorganic fibers contained in the sheet-like member 31 are oriented along a plane perpendicular to the perforation direction of the through holes 32. Therefore, a space that PM contained in the exhaust gas enters and enables the exhaust gas to pass through from one side to the other side of the wall part 33 is easily formed, and the initial pressure loss can be reduced and PM contained in the exhaust gas can be made to enter the inside of the wall part 33 and be trapped.

The sheet-like member 31 may be formed to contain inorganic particles in addition to the inorganic fibers. The inorganic particles may be metal particles or ceramic particles, etc. Examples of metal particles include particles of one or more kinds selected among metal silicon, aluminum, iron (chromium-based stainless steel, chrome-nickel-based stainless steel, etc.,), and titanium. Examples of ceramic particles include particles of one or more kinds selected among oxide-based particles such as alumina, silica, silica-alumina, zirconia, cordierite, mullite, etc., nitride-based particles such as aluminum nitride, silicon nitride, boron nitride, titanium nitride, etc., carbide-based particles such as silicon carbide, zirconium carbide, titanium carbide, tantalum carbide, and tungsten carbide.

The honeycomb filter 30 supports LaCoO₃ having a perovskite structure as a first catalyst. The supporting amount of this first catalyst is about 10 to about 100 g/L as a weight of the first catalyst per unit volume of the honeycomb filter 30. The honeycomb filter 30 which supports the first catalyst may be prepared by supporting the first catalyst in inorganic fibers as a raw material, or may be prepared by supporting the first catalyst on the sheet-like members 31 and the end portion sheet-like members 34, or the first catalyst may be supported after the honeycomb filter 30 is prepared.

Herein, the honeycomb filter 30 may be prepared by laminating sheet-like members 31 mainly made of inorganic foams in place of the sheet-like members 31 containing inorganic fibers. The inorganic foams may be, for example, ceramic foams or metal foams, and metal foams are preferable since they have high strength. Examples of ceramic foams include foams of one or more kinds selected among alumina foam, silica foam, and silicon carbide foam, and examples of metal foams include foams of one or more kinds selected among copper, iron (stainless steel such as chromium stainless steel or chromium-nickel stainless steel, etc.), and aluminum. The porosity of the honeycomb filter 30 made of the inorganic foams is preferably about 75 to about 95% (more preferably, about 80 to about 95%).

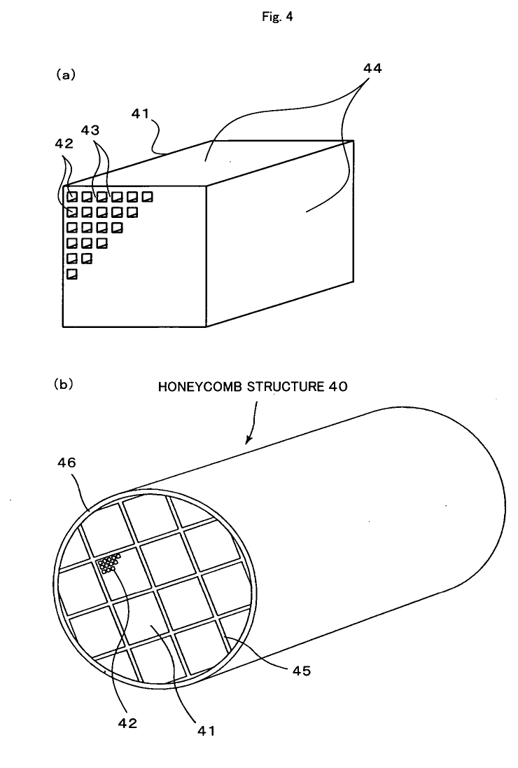

Next, the construction of the honeycomb structure 40 is described with reference to FIG. 4. The honeycomb structure 40 is constructed as a NOx storage catalyst (hereinafter, referred to as NSC) that stores NOx contained in the exhaust gas of the engine 20 and converts it. FIG. 4 is an explanatory view of the honeycomb structure 40, wherein (a) is a perspective view of a porous honeycomb unit 41, and (b) is a perspective view of the honeycomb structure 40. This honeycomb structure 40 is formed by preparing porous honeycomb units 41 having a plurality of through holes 42 and joining the two or more porous honeycomb units 41 via a sealing material layer 45 on their outer faces 44 on which the through holes 42 do not open. The porous honeycomb unit 41 contains ceramic particles, inorganic fibers, and an inorganic binder. As shown in FIG. 4(b), the honeycomb structure 40 has a coating material layer 46 that coats the outer circumferential faces, on which the through holes 42 do not open, of the two or more porous honeycomb units 41 joined by the sealing material layer 45.

The porous honeycomb unit 41 is formed to have a square section on a plane orthogonal to the through holes 42, and the honeycomb structure 40 formed by joining the plurality of porous honeycomb units 41 are formed to have a cylindrical external shape. The porous honeycomb unit 41 may be shaped to have, for example, a rectangular, hexagonal, or fan-shaped section orthogonal to the through holes 42, and the honeycomb structure 40 may be shaped to have, for example, a rectangular pillar section or an oval pillar section on the plane orthogonal to the through holes 42.

The through holes 42 formed in the porous honeycomb unit 41 are formed to be square in section. The section of the through hole 42 may be triangular or hexagonal. The wall thickness between the through holes 12 is preferably in the range of about 0.05 to about 0.35 mm, more preferably about 0.10 to about 0.30 mm, and most preferably about 0.15 to about 0.25 mm. When the wall thickness is about 0.05 mm or more, the strength of the porous honeycomb unit 41 is not easily lowered, and when it is about 0.35 mm or less, the area in contact with the exhaust gas becomes large and the catalyst performance is not easily lowered. The number of through holes per unit sectional area is preferably about 15.5 to about 186/cm² (about 100 to about 1200 cpsi), more preferably about 46.5 to about 170.5/cm² (about 300 to about 1100 cpsi), and most preferably about 62.0 to about 155/cm² (about 400 to about 1000 cpsi). When the number of through holes is about 15.5/cm² or more, the area of the wall to come into contact with the exhaust gas inside the porous honeycomb unit becomes large, and if it is about 186/cm² or less, the pressure loss does not easily become high and manufacturing of the porous honeycomb unit does not become difficult.

The sectional area of the porous honeycomb unit 41 is preferably about 5 to about 50 cm², more preferably about 6 to about 40 cm², and most preferably 8 to 30 cm². In this range, the specific surface area per unit volume of the honeycomb structure 40 can be kept large, and it becomes possible to highly disperse the second catalyst. And even when an external force such as thermal shock or vibration is applied, the shape as the honeycomb structure can be maintained. The percentage of the total sectional area of the porous honeycomb unit 41 to the sectional area of the honeycomb structure 40 is preferably about 85% or more. When this percentage is about 85% or more, the specific surface area to support the second catalyst does not become excessively small and the pressure loss does not become high.

In the porous honeycomb unit 41, alumina particles are used as ceramic particles, silica alumina fibers are used as inorganic fibers, and silica sol is used as an inorganic binder. These ceramic particles, inorganic fibers, and inorganic binder may be selected among those described in the honeycomb filter 30. Although the porous honeycomb unit 41 can be prepared without using the inorganic binder, sufficient strength is obtained even at a low firing temperature by using the inorganic binder.

The content of the ceramic particles in the porous honeycomb unit 41 is preferably about 30 to about 97 weight percent, more preferably about 30 to about 90 weight percent, still more preferably about 40 to about 80 weight percent, and most preferably about 50 to about 75 weight percent. When the content of the ceramic particles is about 30 weight percent or more, the amount of ceramic particles to contribute to improvement in specific surface area does not become relatively small, so that the specific surface area as the honeycomb structure becomes large and it becomes possible to highly disperse the catalyst that converts the exhaust gas when supporting the catalyst, and when the content of the ceramic particles is about 90 weight percent or less, the contents of in organic fibers and in organic binder to contribute to improvement in strength become relatively large, preventing strength of the honeycomb structure to be lowered.

The content of the inorganic fibers in the porous honeycomb unit 41 is preferably about 3 to about 70 weight percent, more preferably about 3 to about 50 weight percent, still more preferably about 5 to about 40 weight percent, and most preferably about 8 to about 30 weight percent. When the content of the inorganic fibers is 3 weight percent or more, the strength of the honeycomb structure is not easily lowered, and when the content of the inorganic fibers is about 70 weight percent or less, the amount of the ceramic particles to contribute to improvement in specific surface area becomes relatively large, so that the specific surface area as the honeycomb structure becomes large and it becomes possible to highly disperse the catalyst for exhaust gas conversion when supporting the catalyst. The average of the aspect ratios of the inorganic fibers is preferably about 2 to about 1000, more preferably about 5 to about 800, and most preferably about 10 to about 500. When the aspect ratio of the inorganic fibers is about 2 or more, the strength of the honeycomb structure is not easily lowered, and when the aspect ratio is about 1000 or less, the forming mold is not easily clogged in the course of molding and moldability is adequately kept.

The content of the inorganic binder in the porous honeycomb unit 41 is preferably about 50 weight percent or less as a solid content in the porous honeycomb unit 41, more preferably about 5 to about 50 weight percent, still more preferably about 10 to about 40 weight percent, and most preferably about 15 to about 35 weight percent. When the content of the inorganic binder is about 50 weight percent or less, the moldability is adequately kept.

In the honeycomb structure 40, platinum as an oxidation catalyst and barium as an NOx storage agent are supported as the second catalyst. As the supporting amount of the second catalyst, platinum is supported by preferably about 1 to about 5 g/L and barium is supported by preferably about 0.1 to about 1 mol/L in weight of the second catalyst per unit volume of the honeycomb structure 40.

Herein, the honeycomb structure 40 contains ceramic particles and inorganic fibers, however, it is also possible that it contains ceramic particles with a predetermined particle diameter and ceramic particles with a particle diameter larger than the predetermined particle diameter. Further, the honeycomb structure may contain an inorganic binder. In this case, the catalyst is also highly dispersed and strength against thermal shock and vibration can be increased. The ceramic particles and inorganic binder used in the honeycomb structure 40 may be selected among those described above. In this case, ceramic particles with the larger particle diameter preferably have a particle diameter of about 5 times or more of the predetermined particle diameter, and more preferably about 10 to about 30 times of the predetermined particle diameter. The particle diameter of the ceramic particles with the larger particle diameter is preferably about 10 to about 60 μm, and more preferably about 20 to about 50 μm. When the particle diameter is about 10 μm or more, the strength of the honeycomb structure 40 can be sufficiently increased, and when the particle diameter is about 60 μm or less, the forming mold is not easily clogged in the course of molding and moldability is adequately kept. When the particle diameter is about 60 μm or less, the contact points of particles are increased and the strength of the honeycomb structure 40 may become high. Herein, particles with the predetermined particle diameter and particles with particle diameters larger than the predetermined particles are distributed, the average of these particle diameters may be used. As ceramic particles with particle diameters larger than the predetermined particle diameter, a different kind from the ceramic particles with the predetermined particle diameter may be selected, or ceramic particles that are the same kind as the ceramic particles with the predetermined particle diameter and have different shapes or different physical properties (for example, the crystal form is different and the melting temperature is different) may be selected.

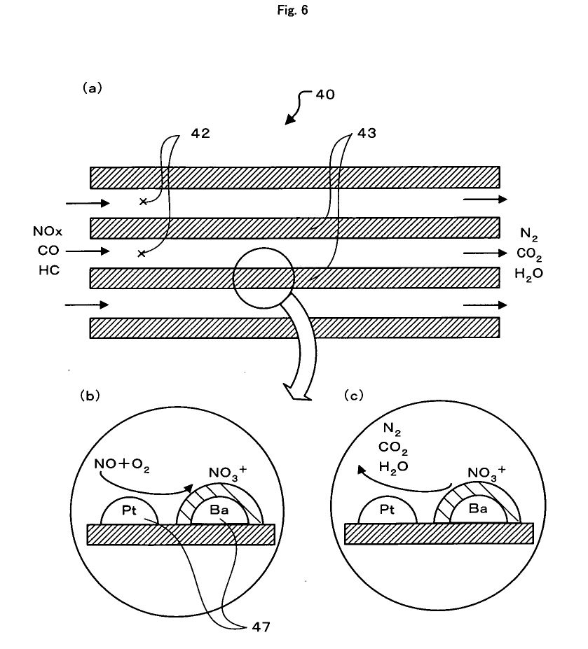

Next, action of the exhaust gas cleanup system 10 of this embodiment is described with reference to FIG. 5 and FIG. 6. FIG. 5 is a schematic view of purification of PM by the honeycomb filter 30, and FIG. 6 is a schematic view of conversion of harmful substances contained in the exhaust gas by the honeycomb structure 40, wherein (a) is a schematic view of the honeycomb structure 40, (b) is a schematic view when storing NOx, and (c) is a schematic view when discharging NOx. First, the engine 20 is started. Then, the engine 20 burns a fuel by injecting it into air compressed by a piston to generate a driving force. At this point, an exhaust gas containing PM, NOx, HC, and CO is exhausted to the manifold 22 from the engine 20 and flows into the honeycomb filter 30. In the wall part 33 of the honeycomb filter 30, a space which PM enters is formed, and PM contained in the exhaust gas is made to enter the inside of the wall 33 supporting a catalyst 37 for exhaust gas purification and is trapped. Herein, when many inorganic fibers 35 contained in the honeycomb filter 30 are oriented along the surface perpendicular to the perforation direction of the through holes 32, it is thought that PM enters the deeper inside of the wall part 33 and is trapped. The honeycomb filter 30 is disposed at a position of about 1 m from the engine 20, and the exhaust gas reaches the honeycomb filter 30 while keeping a high temperature without great heat removal by the exhaust path (for example, exhaust pipe, etc.). As a result, the first catalyst supported on the honeycomb filter 30 is quickly raised in temperature by the exhaust gas to a temperature that makes the catalyst sufficiently perform the catalyst function, in particular, a temperature that easily burns PM (for example, about 400° C. or more). Particularly, the honeycomb filter 30 has a high porosity of about 80% or more and a small heat capacity, so that it is quickly raised in temperature by the exhaust gas. In this case, when PM comes into contact with the catalyst 37 supported inside the wall part 33 of the honeycomb filter 30, the PM is quickly burned. As a result, PM hardly deposits on the honeycomb filter 30, and the frequency of forcibly regenerating (injecting an excessive amount of fuel) is reduced. Most of PM is converted into carbon dioxide (CO₂) due to PM burning, however, CO may be produced due to partial imperfect combustion.

The exhaust gas from which PM has been removed by the honeycomb filter 30 flows into the honeycomb structure 40 disposed on the downstream of the honeycomb filter 30 (see FIG. 6). In this exhaust gas, NOx (mainly NO), HC, and CO are contained. This CO also contains substances produced due to imperfect combustion of PM. The honeycomb structure 40 is disposed at a position of about 3 m from the engine 20, and the exhaust gas reaches the honeycomb structure 40 without great heat removal by the exhaust path (such as the exhaust pipe 24), so that the second catalyst supported by the honeycomb structure 40 is raised in temperature by the exhaust gas to a temperature that makes the catalyst perform the catalyst function (for example, about 200° C. or more). Then, when the air-fuel ratio is lean, NOx contained in the exhaust gas is stored in the form of NO³⁺ in the NOx storage agent (barium) (FIG. 6(b). On the other hand, when the air-fuel ratio is rich, under the presence of stored NO³⁺, the oxidation catalyst (platinum) cleans and converts HC and CO into nitrogen (N₂), water (H₂O), and carbon dioxide (CO₂) (FIG. 6(c)). Thus, harmful substances (NOx, HC, CO, etc.) contained in the exhaust gas and harmful substances (CO, etc.) produced by burning particulate materials trapped by the honeycomb filter 30 are converted.

Next, examples of methods of manufacturing honeycomb filters 30 using inorganic fibers, ceramic foams, and metal foams, respectively, and a method for manufacturing a honeycomb structure 40 using ceramic particles, inorganic fibers, and inorganic binders are described below.

1. Method for Manufacturing Honeycomb Filter 30

(1) An example of a method for manufacturing a honeycomb filter 30 by using inorganic fibers is described. Inorganic fibers (alumina fibers or the like) are dispersed in a proportion of about 5 g to about 100 g to 1 L of water, an inorganic binder (silica sol or the like) is added in a proportion of about 10 to about 40 parts by weight and an organic binder (acryl resin or the like) is added in a proportion of about 1 to about 10 parts by weight to about 100 parts by weight of the inorganic fibers, and furthermore, as appropriate, small amounts of a coagulant such as aluminum sulfate and a flocculant such as polyacrylamide are added, and these are sufficiently stirred to prepare a papermaking slurry. The papermaking slurry is screened through a perforated mesh so as to have holes of a predetermined shape (square, etc.) at predetermined intervals, and the obtained article is dried at about 100 to about 200° C., whereby the sheet-like member 31 shown in FIG. 2(c) is obtained. The sheet-like member 31 including inorganic fibers is elastically deformable when a pressure is applied thereto, so that its porosity and thickness are adjusted by compressing the sheet-like member as appropriate. Herein, for example, when a honeycomb filter 30 is integrally molded by means of extrusion molding by using a mold, many inorganic fibers are oriented in the extrusion direction (perforation direction of the through holes 32), however, when it is manufactured by this papermaking process, as shown in FIG. 2, a larger amount of inorganic fibers are oriented along a plane perpendicular to the perforation direction of the through holes 32. Therefore, a space which PM enters and enables the exhaust gas to flow from one side to the other side of the wall part 33 is easily formed inside the wall part 33 in the orientation direction of the inorganic fibers, and it becomes easy for the exhaust gas to pass through the wall part 33. Next, the end portion sheet-like members 34 are prepared by forming holes with a predetermined shape in a metal plate so that both ends of the through holes 32 are alternately clogged (see FIG. 2(b)).

Subsequently, the first catalyst is supported on the sheet-like members 31. First, a solution (for example, slurry or sol) containing the first catalyst is prepared, and the sheet-like members 31 are soaked in this solution and then taken out, and extra solution remaining in the through holes 32 or the like is removed by being suctioned. Then, drying is performed at about 80 to about 200° C. and firing is performed at about 500 to about 700° C., whereby sheet-like members 31 supporting the first catalyst can be obtained. The solution containing the first catalyst may be a slurry of the catalyst for exhaust gas purification, or may be a slurry of oxide (alumina or the like) supporting the first catalyst. The kinds and combination of the first catalyst are properly selected according to the purpose of use, and as the supporting amount of the first catalyst, an amount that can sufficiently purify the exhaust gas is properly selected according to the selected catalyst kinds and combination. Last, a honeycomb filter 30 is prepared by physically laminating the sheet-like members 31 and end portion sheet-like members 34. As shown in FIG. 3, several end portion sheet-like members 34 are laminated and inserted into a metal-made first casing 38 so that communicating holes 36 are formed by communicating the through holes 32, and then a predetermined number (for example, about 10 to about 200) of the sheet-like members 31 are laminated and inserted in the same manner, and furthermore, a pressure is applied by a press in the direction of insertion and lamination of the several end portion sheet-like members 34 to pressure-bond the laminated end portion sheet-like members 34 and sheet-like members 31, and a presser fitting is set and fixed, whereby the honeycomb filter 30 is obtained. The laminated end portion sheet-like members 34 may be bonded and fixed to each other by using an adhesive. For convenience of explanation, the first casing 38 of FIG. 3 is shown at only the lower portion of the upper and lower portions obtained by cutting the hollow columnar first casing 38.

(2) Next, an example of a method for manufacturing the honeycomb filter 30 by using ceramic foams is described. Through holes 32 are formed by cutting in a high-porosity ceramic foam plate (for example, ceramic foam made by Bridgestone) mainly made of a ceramic material (for example, cordierite, alumina, mullite, silicon carbide, and aluminum titanate, etc.), whereby the sheet-like member 31 described in (1) given above is obtained. The first catalyst is supported onto the obtained plurality of sheet-like members 31 by the method described in (1) given above, and the sheet-like members are laminated by the method described in (1) given above, whereby a honeycomb filter 30 is obtained. As the end portion sheet-like member 34, one made of metal, described in (1) given above, is used.

(3) Next, an example of the method for manufacturing a honeycomb filter 30 by using metal foam is described. Through holes 32 are formed by means of laser machining in a high-porosity metal plate (for example, Celmet made by Sumitomo Electric Industries, Ltd.), whereby a sheet-like member 31 shaped as described in (1) given above is obtained. Then, the first catalyst is supported onto the obtained plurality of sheet-like members 31 by the method described in (1) given above, and the sheet-like members are laminated by the method described in (1) given above to manufacture a honeycomb filter 30. The sheet-like members 31 formed of metal foams are deformable by being applied with a pressure, so that the porosity and thickness are adjusted by compressing the sheet-like members as appropriate. The end portion sheet-like members 34 are made of metal as described in (1) given above.

2. Method for Manufacturing Honeycomb Structure 40

Next, an example of the manufacturing method for the honeycomb structure 40 of the invention described above is explained. First, alumina particles as ceramic particles, silica-alumina fibers as inorganic fibers and silica sol as an inorganic binder are mixed to prepare a raw material paste. An organic binder, a dispersion medium, and a molding aid may be added as appropriate to the raw material paste according to the moldability. As the organic binder, for example, one or more organic binders selected among methylcellulose, carboxymethylcellulose, hydroxyethylcellulose, polyethylene glycol, phenol resin, and epoxy resin may be used. The blending amount of the organic binder is preferably about 1 to about 10 weight percent to a total of 100 parts by weight of the alumina particles, silica-alumina fibers, and silica sol. As the dispersion medium, for example, water, an organic solvent (benzene, etc.), alcohol (methanol, etc.), and so on may be used. As the molding aid, for example, ethylene glycol, dextrin, fatty acid, fatty acid soap, and polyalcohol, etc., may be used. A mixer or attriter may be used for mixing the raw materials, or the raw materials are sufficiently kneaded by a kneader. As a method for molding the raw material paste, a shape having through holes is molded by means of, for example, extrusion molding.

The obtained molding is dried. As the drying machine, for example, a microwave dryer or hot air dryer is used. When an organic binder and the like are added, degreasing is preferably performed. The degreasing conditions are properly selected depending on the kinds and amounts of the organic materials contained in the molding, and are preferably about 400° C. and about 2 hours. Next, the dried and degreased molding is fired at about 600 to about 1000° C. When the firing temperature is about 600° C. or more, sintering of the ceramic particles, etc., is advanced and the strength as a honeycomb structure is not easily lowered, and when the firing temperature is about 1000° C. or less, sintering of ceramic particles, etc., is not excessively advanced and the specific surface area per unit volume becomes large, and the catalyst for exhaust gas conversion to be supported can be sufficiently highly dispersed. Through these processes, a porous honeycomb unit 41 having a plurality of through holes is obtained.

Next, a sealing material paste to become a sealing material layer is applied to the obtained porous honeycomb units 41 and the porous honeycomb units 41 are successively joined to each other, and then dried and solidified to prepare a honeycomb unit joined body. As a sealing material, for example, an inorganic binder mixed with ceramic particles, an inorganic binder mixed with inorganic fibers, an inorganic binder mixed with ceramic particles and inorganic fibers, or the like may be used. An organic binder is allowed to be added to these sealing materials. As the organic binder, for example, one or more organic binders selected among polyvinyl alcohol, methylcellulose, ethylcellulose, carboxymethylcellulose, and so on may be used. The thickness of the sealing material layer that joins the porous honeycomb units is preferably about 0.5 to about 2 mm. The thickness of about 0.5 mm or more preferably allows for sufficient joint strength. The thickness of about 2 mm or less preferably prevents the specific surface area per unit volume of the honeycomb structure from being lowered. The reason for this is that the sealing material layer is a portion that does not function as a catalyst support. In addition, when the thickness of the sealing material layer is about 2 mm or less, the pressure loss does not easily increase. The number of porous honeycomb units to be joined to each other are properly determined according to the size of the honeycomb structure to be used. Next, the honeycomb unit joined body is properly cut and ground to the size of the honeycomb structure, and a coating material is applied to the outer circumferential face (side face) in which no through hole is open and then dried and solidified to form a coating material layer. The outer circumferential face is thus protected and the strength is increased. The coating material may have the same composition and blending proportions as those of the sealing material, or may have different composition and blending proportions. The thickness of the coating material layer is preferably about 0.1 to about 2 mm. Then, the joined body thus obtained is calcined to form a honeycomb support (a honeycomb structure before supporting the catalyst). The calcining conditions may be properly determined depending on the kinds and amounts of containing organic materials, and are preferably set to about 700° C. and about 2 hours.

Subsequently, the second catalyst is supported on the obtained honeycomb support. Herein, platinum as an oxidation catalyst and barium as an NOx storage agent are supported. First, a solution (for example, slurry or sol) containing the second catalyst is prepared, and the honeycomb support is soaked in this solution and then taken out, and extra solution remaining in the through holes 42 or the like is removed by being suctioned. Then, the honeycomb support is dried at about 80 to about 200° C. and fired at about 500 to about 700° C., whereby a honeycomb structure 40 supporting the second catalyst is obtained. The solution containing the second catalyst may be a slurry of the second catalyst or a slurry of oxide (alumina, etc.) supporting the second catalyst. When several kinds of second catalysts are supported, the process of soaking the honeycomb support in a solution of the second catalysts and firing it may be repeated for each second catalyst. The supporting amount of the second catalysts is properly selected depending on its kinds and combination. The second catalyst may be supported after forming a honeycomb support, or may be supported at the stage of ceramic particles of the raw material.

In the exhaust gas cleanup system 10 of this embodiment described above, the first catalyst 37 supported by the honeycomb filter 30 is quickly raised in temperature by the exhaust gas and starts sufficiently performing the catalyst function, and in addition, the porosity of about 75% or more allows easy contact with PM, so that a greater amount of PM can be efficiently burned. Therefore, the honeycomb filter 30 can easily be regenerated. In addition, in comparison with the case where PM is trapped only in the wall surface supporting the catalyst, PM is trapped inside the wall part 33 supporting the first catalyst in the structure described above, so that the probability of contact between PM and the first catalyst 37 is increased and PM burning efficiency is increased. Furthermore, even when a heat stress is applied due to a temperature difference in the longitudinal direction of the honeycomb filter 30 caused by PM burning heat, the stress can be reduced between the laminated sheet-like members 32, so that damage due to the heat stress is less likely to occur than in the case of integral molding in the longitudinal direction. The honeycomb filter 30 has a high porosity and a small heat capacity, so it quickly rises in temperature and enables PM to be burned. In addition, the first catalyst 37 supported by the honeycomb filter 30 is an oxide having a perovskite structure, so PM can be burned while the use amount of precious metals (platinum and the like) as precious elements is reduced.

The honeycomb structure 40 is disposed at a position of an exhaust path length of about 3 m or less from the engine 20, so that the exhaust gas reaches the honeycomb structure 40 without great heat removal by the exhaust pipe 24 or the like, and therefore, the second catalyst supported in the honeycomb structure 40 is made to function by using the heat of the exhaust gas and a plurality of harmful substances contained in the exhaust gas are easily converted. Furthermore, the honeycomb structure 40 is structured by joining a plurality of porous honeycomb units 41 via sealing material layer 45, so that the honeycomb structure highly disperses the catalyst and has high strength against thermal shock and vibrations.

Furthermore, in the exhaust gas cleanup system 10, CO produced due to imperfect combustion of PM at the honeycomb filter 30 disposed on the upstream side is also converted by the honeycomb structure 40 disposed on the downstream side, so that it is not necessary to further dispose a catalyst support or the like that converts harmful substances on the downstream of the honeycomb structure 40.

The invention is not limited to the embodiments described above, and the invention can be carried out in various modes as long as the modes are within the technical scope of the invention.

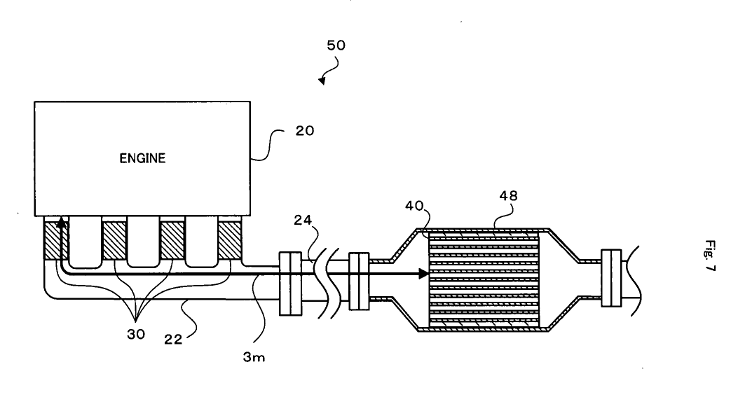

For example, in the above-described embodiments, the exhaust gas cleanup system 10 includes a first casing 38 retaining the honeycomb filter 30 connected to the manifold 22, however, as shown in FIG. 7, the exhaust gas cleanup system 50 including a honeycomb filter 30 disposed inside the manifold 22 is also possible.

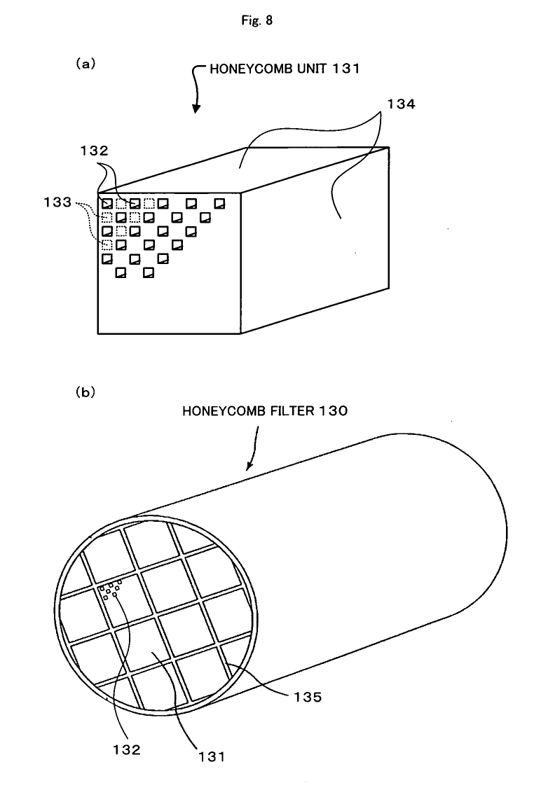

In the above-described embodiment, the honeycomb filter 30 is formed by laminating, in the longitudinal direction, two or more disk-shaped sheet-like members 31 having a plurality of through holes 32 so that the through holes 32 communicate with each other. It is also possible, as one modified structure, that the honeycomb filter is molded into a cylindrical shape having through holes by means of integral molding and the end faces of the through holes are alternately clogged. In addition, as shown in FIG. 8, the honeycomb filter 130 may be formed by molding rectangular pillar-shaped honeycomb units 131 having through holes 132, alternately clogging the end faces of the through holes 132 by clogging portions 133, joining the outer faces 134 by a sealing material layer 135, and machining the external form into a columnar shape.

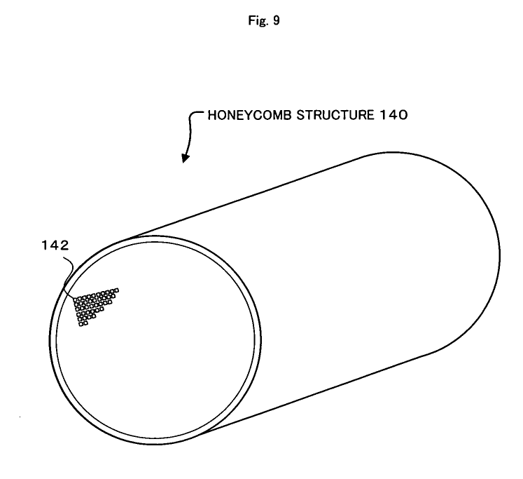

In the above-described embodiments, the honeycomb structure 40 is formed by joining two or more porous honeycomb units 41 having a plurality of through holes 42 on their outer faces 44 by the sealing material layer 45. It is also possible, as one modified structure, that the honeycomb structure 140 is integrally molded into a cylindrical shape having through holes 142, as shown in FIG. 9. It is also possible that the honeycomb structure is formed by laminating, in the longitudinal direction, two or more disk-shaped sheet-like members having a plurality of through holes so that the through holes communicate with each other. In these cases, a plurality of harmful substances can also be converted by the honeycomb structure.

In the above-described embodiment, the exhaust gas cleanup system 10 is loaded in an automobile. The exhaust gas cleanup system may be loaded in, for example, a train, a vessel, or an aircraft, etc., or applied to a generator using the engine 20.

### EXAMPLES

### Example 1

Hereinafter, an example (example 1) of an exhaust gas cleanup system 10 using the honeycomb filter 30 and the honeycomb structure 40 is described.

Method for Manufacturing a Honeycomb Filter 30 (DPF-A)

A honeycomb filter 30 that contains alumina fibers (average diameter: 5 μm, average length: 300 μm) as inorganic fibers was manufactured. Alumina fibers were dispersed in the proportion of 10 g to 1 L of water, silica sol was added in the proportion of 5 weight percent to alumina fibers, an acryl resin was added in the proportion of 3 weight percent, and furthermore, small amounts of aluminum sulfate and polyacrylamide were added and sufficiently stirred, whereby a papermaking slurry was prepared. This papermaking slurry was screened through a perforated mesh having square holes formed at predetermined intervals, and then the obtained article was dried at 150° C., whereby a sheet-like member 31 was obtained which had a diameter of 143.8 mm, a thickness of 1 mm, through holes with a size of a 4.5 mm square, a thickness of the wall part 33 of 2 mm, and a cell density of 2.4/cm² (15.2 cpsi). In addition, an end portion sheet-like member 34 was manufactured by perforating through holes 32 in a metal plate made of nickel-chromium-based stainless steel with a diameter of 143.8 mm and a thickness of 1.0 mm so that both ends of the through holes 32 were alternately clogged.

Next, 0.01 moles of La(NO₃)₃.6H₂O, 0.01 moles of Co(OCOCH₃)₂.4H₂O, and 0.024 moles of C₆H₈O₇H₂O (citric acid) were mixed and stirred in 20 ml of ethanol solvent to prepare LaCoO₃ precursor sol. The sheet-like member 31 was soaked in this sol and taken out, and then extra sol was removed by being suctioned, and the member was dried at 100° C. and fired for 1 hour at 600° C. This supporting amount of the catalyst for exhaust gas purification was 30 g/L in terms of the weight of the catalyst for exhaust gas purification per unit volume of the honeycomb filter 30 (72 g in terms of the weight of LaCoO₃ with respect to the honeycomb filter). The supporting amount of the catalyst for exhaust gas purification was confirmed based on a weight increase of the honeycomb filter. The perovskite structure of LaCoO₃ was confirmed by means of X-ray diffraction measurement.

Next, three end portion sheet-like members 34 were laminated and inserted into a metal casing 38 so that the through holes 32 communicated with each other, and then 150 sheet-like members 31 were laminated and inserted in the same manner, and the three end portion sheet-like members 34 were pressure-bonded by applying a pressure in their insertion and lamination direction by a press and fixed by setting a presser fitting, whereby the honeycomb filter 30 shown in FIG. 3 was obtained (DPF-A). The porosity of the obtained honeycomb filter 30 (DPF-A) was 80%. The porosity was calculated by using the formula 1 described below. The structure, the main components, and various values such as the platinum supporting amount, the porosity, the unit area ratio (the percentage of the total sectional area of the porous honeycomb units to the sectional area of the honeycomb structure), and so on of this DPF-A are shown in Table 1. In this Table 1, the details of DPF-B and DPF-C and NSC-D through F described later are also shown.

TABLE 1

| | | | Catalyst | | | |
|---|---|---|---|---|---|---|
| | | | supporting | | | Unit |
| | | | Amount | | | Area |
| | | Main | Pt | LaCoO₃ | Porosity | Ratio |
| Sample¹⁾ | Structure | component | (g) | (g) | (%) | (%) |
| DPF-A | Laminated | Alumina | 0 | 72 | 80 | — |
| | | fibers | | | | |
| DPF-B | Joined | Silicon | 0 | 72 | 60 | 93.5 |
| | | carbide | | | | |
| | | particles | | | | |
| DPF-C | Joined | Silicon | 4.8 | 0 | 60 | 93.5 |
| | | carbide | | | | |
| | | particles | | | | |
| NSC-D | Joined | Alumina | 4.8 | 0 | 60 | 93.5 |
| | | particles | | | | |
| NSC-E | Integral | Cordierite | 12 | 0 | | — |
| NSC-F | Integral | Cordierite | 4.8 | 0 | | — |

¹⁾143.8 mm in diameter × 150 mm in length

Method for Manufacturing Honeycomb Structure 40 (NSC-D)

First, 40 weight percent of γ alumina particles (average particle diameter: 2 μm), 10 weight percent of silica-alumina fibers (average fiber diameter: 10 μm, average fiber length: 100 μm, aspect ratio: 10), and 50 weight percent of silica sol (solid concentration: 30 weight percent) were mixed, and to 100 parts by weight of the obtained mixture, 6 parts by weight of methylcellulose as an organic binder and small amounts of a plasticizer and a lubricant were added, mixed, and kneaded, whereby a mixed composition was obtained. Next, this mixed composition was extruded, by an extruder, into a rectangular column shape with a plurality of through holes arranged in the longitudinal direction, whereby a raw molding was obtained. Then, the raw molding was sufficiently dried by using a microwave dryer and a hot air dryer, and left at 400° C. for 2 hours and degreased. Thereafter, the molding was left at 800° C. for 2 hours and fired, whereby a porous honeycomb unit 41 was obtained which had a rectangular pillar shape (34.3 mm×34.3 mm×150 mm), a cell density of 93/cm² (600 cpsi), a wall thickness of 0.2 mm, and a quadrilateral (square) cell shape. Next, 29 weight percent of γ alumina particles (average particle diameter: 2 μm), 7 weight percent of silica-alumina fibers (average fiber diameter: 10 μm, average fiber length: 100 μm), 34 weight percent of silica sol (solid concentration: 30 weight percent), 5 weight percent of carboxymethylcellulose and 25 weight percent of water were mixed to prepare sealing material paste. This sealing material paste was applied so as to be a thickness of 1 mm on the outer faces 13 of the porous honeycomb units to join the porous honeycomb units 41, whereby a joined body was obtained. Then, the joined body was cut by using a diamond cutter into a columnar shape so that the front face of the joined body became roughly symmetrical about a point, and the sealing material paste was applied so as to be a 0.5 mm thickness on the circular outer surface that had no through holes to coat the outer surfaces. Thereafter, the joined body was dried at 120° C., and left at 700° C. for 2 hours and the sealing material layer and the coating material layer were degreased, whereby a honeycomb support having a cylindrical shape (143.8 mmφ in diameter×150 mm in height) was obtained.

Barium and platinum were supported on the obtained honeycomb support. First, a 0.5 mol/L solution of barium nitrate was prepared. Next, this barium nitrate solution was absorbed in the honeycomb structure so that the barium supporting amount became 0.3 mol/L in terms of the number of moles of barium per unit volume of the honeycomb structure, dried at 250° C. for 15 minutes, and fired at 500° C. for 30 minutes. Next, a 0.25 mol/L solution of platinum nitrate was prepared. This platinum nitrate solution was absorbed in the honeycomb structure so that the platinum supporting amount became 2.0 g/L in terms of the weight of platinum per unit volume of the honeycomb structure (4.8 g in terms of the weight of platinum with respect to the honeycomb structure), and fired at 600° C. for 1 hour. Thereby, a honeycomb structure 40 (NSC-D) as the NOx storage catalyst shown in FIG. 4 was obtained. The porosity of the obtained honeycomb structure 40 (NSC-D) was 60%, the specific surface area per unit volume of the honeycomb structure 40 (NSC-D) was 39270 m²/L, and the unit area ratio was 93.5%. The specific surface area per unit volume was calculated by using the formula 2 described later.

Subsequently, the DPF-A was disposed at the position of a length of 1 m from the engine 20 (the length of the exhaust path from the extreme upstream portion of the manifold 22 to the front end of the DPF-A, the same applies to the description below) and the NSC-D was disposed at the position of a length of 3 m from the engine 20. This was defined as example 1. The engine 20 was a 2.0 L diesel engine. The length of the DPF and NSC from the engine 20 in this example 1 and their platinum supporting amounts are shown in Table 2. Descriptions concerning examples 2 through 11 are also shown in Table 2. In addition, the conversion/purification rates of CO, HC, NOx, and PM described later, the regenerating rate of PM, the maximum temperature of the DPF during 10-15 mode measurement, and the time until the DPF reaches the maximum temperature after the exhaust gas reaches its maximum temperature are also shown in Table 2.

TABLE 2

| | Upstream side¹⁾ | | Pt | LaCoO₃ | Downstream side¹⁾ | | Pt | LaCoO₃ |
|---|---|---|---|---|---|---|---|---|
| | purification/conversion | Distance²⁾ | Amount | Amount | purification/conversion | Distance²⁾ | Amount | Amount |
| | apparatus | (m) | (g) | (g) | apparatus | (m) | (g) | (g) |
| Example 1 | DPF-A | 1 | 0 | 72 | NSC-D | 3 | 4.8 | 0 |
| Example 2 | DPF-B | 1 | 0 | 72 | NSC-E | 3 | 12 | 0 |
| Example 3 | DPF-A | 1 | 0 | 72 | NSC-D | 1.2 | 4.8 | 0 |
| Example 4 | DPF-A | 1 | 0 | 72 | NSC-F | 3 | 4.8 | 0 |
| Example 5 | DPF-B | 1 | 0 | 72 | NSC-F | 3 | 4.8 | 0 |
| Example 6 | NSC-D | 3 | 4.8 | 0 | DPF-A | 3.2 | 0 | 72 |
| Example 7 | NSC-D | 3 | 4.8 | 0 | DPF-C | 3.2 | 4.8 | 0 |
| Example 8 | NSC-E | 3 | 4.8 | 0 | DPF-C | 3.2 | 4.8 | 0 |
| Example 9 | DPF-A | 3 | 0 | 72 | NSC-D | 3.2 | 4.8 | 0 |
| Example 10 | DPF-C | 3 | 4.8 | 0 | NSC-D | 3.2 | 4.8 | 0 |
| Example 11 | DPF-C | 3 | 4.8 | 0 | NSC-E | 3.2 | 12 | 0 |

| | Conversion/purification | | | | Regenerating | Maximum³⁾ | |
|---|---|---|---|---|---|---|---|
| | Rate (%) | | | | Rate | Temperature | Time⁴⁾ |
| | CO | HC | NOx | PM | (%) | (° C.) | (s) |
| Example 1 | 98 | 95 | 91 | 100 | 75 | 430 | 10 |
| Example 2 | 96 | 92 | 90 | 100 | 51 | 410 | 25 |
| Example 3 | 98 | 95 | 92 | 100 | 75 | 430 | 10 |
| Example 4 | 68 | 56 | 78 | 100 | 75 | 430 | 10 |
| Example 5 | 68 | 60 | 76 | 100 | 51 | 410 | 25 |
| Example 6 | 78 | 95 | 88 | 100 | 40 | 380 | 20 |
| Example 7 | 84 | 95 | 86 | 100 | 20 | 360 | 35 |
| Example 8 | 83 | 92 | 86 | 100 | 20 | 360 | 35 |
| Example 9 | 98 | 95 | 92 | 100 | 10 | 350 | 20 |
| Example 10 | 98 | 94 | 92 | 100 | 0 | 330 | 35 |
| Example 11 | 95 | 92 | 90 | 100 | 0 | 330 | 35 |

¹⁾143.8 mm in diameter × 150 mm in length
DPF-A: ceramic fiber, lamination structure, porosity of 80%
DPF-B: SiC, integral structure, porosity of 60%
DPF-C: SiC, integral structure, porosity of 60% (catalyst support: 120 g/L alumina)
NSC-D: honeycomb structure, joined structure, porosity of 60%
NSC-E, F: cordierite, integral structure (catalyst support: 120 g/L alumina)
²⁾Distance from engine
³⁾Maximum temperature of DPF during 10-15 mode measurement
⁴⁾Time until DPF reaches its maximum temperature after exhaust gas reaches its maximum temperature

### Example 2

Next, an example (example 2) of an exhaust gas cleanup system 10 using the honeycomb filter 130 and the honeycomb structure 140 is described.

Method for Manufacturing Honeycomb Filter 130 (DPF-B)

7000 parts by weight of α-type silicon carbide powder (average particle diameter: 10 μm), 3000 parts by weight of α-type silicon carbide powder (average particle diameter: 0.5 μm), 1000 parts by weight of acryl particles as a pore forming agent, and 3700 parts by weight of water were mixed, and furthermore, 2000 parts by weight of methylcellulose as an organic binder, 300 parts by weight of glycerin as a plasticizer, and 660 parts by weight of a lubricant (product name: UNILUB made by NOF Corporation) were added and kneaded, whereby a green body was obtained. This green body was extruded into a rectangular column shape having a plurality of through holes arranged side by side in the longitudinal direction to obtain a raw molding. Next, the obtained raw molding was dried, and the plurality of through holes were alternately clogged by using said green body so that a through hole having one end face clogged and the other end face open and a through hole with one end face open and the other end face clogged were alternately arranged side by side. Then, the molding was degreased in the air of 400° C. for 3 hours and fired at 2200° C. for 3 hours under the atmosphere of argon at a normal pressure, whereby a fired material made of silicon carbide with a size of 34.3 mm×34.3 mm×150 mm, a thickness of the wall part 33 of 0.3 mm, and a cell density of 46.5/cm² (300 cpsi) was prepared. Next, the sealing material paste was applied so as to be a 1 mm thickness on the outer face 13 of this fired material and a plurality of fired materials were bonded by a sealing material layer 26 dried and solidified at 120° C., and shaped into a columnar shape (143.8 mmφ in diameter×150 mm in height) by using a diamond cutter or the like. In this cylindrical material, the outer circumferential surface at the portions without the through holes 12 being open was coated by a 0.5 mm thickness of coating material paste to form a coating material layer 27, whereby a filter support (meaning the honeycomb filter before supporting the catalyst) was obtained through a process of drying at 120° C. for 1 hour. The sealing material paste used herein had a composition of 30 weight percent of alumina fibers (fiber length: 20 μm), 21 weight percent of silicon carbide particles (average particle diameter: 0.6 μm), 15 weight percent of silica sol (silica content in sol: 30 weight percent), 5.6 weight percent of carboxymethylcellulose, and 28.4 weight percent of water. The coating material paste used herein had a composition of 23.3 weight percent of silica-alumina fibers (fiber length: 5 through 100 μm), 30.2 weight percent of silicon carbide particles (average particle diameter: 0.3 μm), 7 weight percent of silica sol (silica content in sol: 30 weight percent), 0.5 weight percent of carboxymethylcellulose, and 39 weight percent of water. LaCoO₃ was supported on the obtained honeycomb filter support in the same manner as in the case of DPF-A described above so that the supporting amount became 30 g/L, whereby the honeycomb filter 130 (DPF-B) shown in FIG. 8 was obtained. The porosity of the obtained honeycomb filter 130 (DPF-B) was 60%, and the percentage (unit area ratio) of the total sectional area of the fired materials to the sectional area of the honeycomb filter 130 (DPF-B) was 93.5%.

Method for Manufacturing Honeycomb Structure 140 (NSC-E)

A commercially available cordierite support was prepared. This cordierite support had a diameter of 143.8 mm, a length of 150 mm, a through hole size of a 4.5 mm square, a thickness of the wall part 33 of 2 mm, and a cell density of 2.4/cm² (15.2 cpsi). 100 parts by weight of γ alumina powder (average particle size: 2 μm) was mixed with 200 parts by weight of water, and 20 parts by weight of nitric acid was added, whereby a wash-coating slurry was prepared. The cordierite support was soaked in this slurry and taken out, and then extra slurry was removed, and the cordierite support was dried at 250° C. for 15 minutes. The alumina supporting amount was 120 g/L in terms of the weight per unit volume of the honeycomb structure. Next, a 0.5 mol/L solution of barium nitrate was prepared, and this barium nitrate solution was absorbed in the cordierite support so that the barium supporting amount became 0.3 mol/L in terms of the number of moles of barium per unit volume of the honeycomb structure, dried at 250° C. for 15 minutes, and fired at 500° C. for 30 minutes. Next, a 0.25 mol/L solution of platinum nitrate was prepared. This platinum nitrate solution was absorbed in the honeycomb support so that the platinum supporting amount became 5.0 g/L in terms of the weight of platinum per unit volume of the honeycomb structure (12 g in terms of the weight of platinum with respect to the honeycomb structure), and fired at 600° C. for 1 hour. Thereby, a honeycomb structure 140 (NSC-E) as the NOx storage catalyst shown in FIG. 9 was obtained. The specific surface area per unit volume of the obtained honeycomb structure 140 (NSC-E) was 25000 m²/L.

In the experiment example 2, the DPF-B was disposed at a position of 1 m in length from the engine 20 and the NSC-E was disposed at a position of 3 m in length from the engine 20. The NSC-D was disposed at a position of 3 m in length from the engine 20, and the DPF-A was disposed at a position of 3.2 m in length from the engine 20. This is the example 2.

Next, examples (examples 3, 6, and 9) of exhaust gas cleanup systems 10 using the honeycomb filter 30 and the honeycomb structure 40 are described.

### Examples 3, 6, and 9

In the examples 3, 6, and 9, the same DPF-A and NSC-D as those of the example 1 were used. In the example 3, a DPF-A sample was disposed at a position of 1 m in length from the engine 20, and a NSC-D sample was disposed at a position of 1.2 m in length from the engine 20. In the example 6, a NSC-D was disposed at a position of 3 m in length from the engine 20, and a DPF-A was disposed at a position of 3.2 m in length from the engine 20. In the example 9, a DPF-A sample was disposed at a position of 3 m in length from the engine 20, and an NSC-D sample was disposed at a position of 3.2 m in length from the engine 20.

### Example 4

Next, an example (example 4) of an exhaust gas cleanup system 10 using the honeycomb filter 30 and the honeycomb structure 140 is described.

Method for Manufacturing Honeycomb Structure 140 (NSC-F)

A commercially available cordierite support similar to that of the above-described NSC-E was prepared, and in the same manner as in the case of the above-described NSC-E, barium and platinum were supported on this cordierite support so that the barium supporting amount became 0.3 mol/L in terms of the number of moles of barium per unit volume of the honeycomb structure, and the platinum supporting amount became 20 g/L in terms of the weight of platinum per unit volume of the honeycomb structure (4.8 g in terms of the weight of platinum with respect to the honeycomb structure), whereby a honeycomb structure (NSC-F) as the NOx storage catalyst shown in FIG. 9 was obtained. The specific surface area per unit volume of the obtained honeycomb structure 140 (NSC-F) was 25000 m²/L. In the example 4, a DPF-A and an NSC-F were used. In the example 4, a DPF-A sample was disposed at a position of 1 m in length from the engine 20, and an NSC-F sample was disposed at a position of 3.0 m in length from the engine 20.

### Example 5

Next, an example (example 5) of an exhaust gas cleanup system 10 using the honeycomb filter 130 and the honeycomb structure 140 is described. In this example 5, a DPF-B and an NSC-F were used. In this example 5, a DPF-B sample was disposed at a position of 1 m in length from the engine 20, and an NSC-F sample was disposed at a position of 3.0 m in length from the engine 20.

### Examples 7 and 10

Next, examples (examples 7 and 10) of exhaust gas cleanup systems 10 using the honeycomb filter 130 and the honeycomb structure 40 are described.

Method for Manufacturing Honeycomb Filter 130 (DPF-C)

A filter support made of silicon carbide like the above-described DPF-B was prepared. Next, 100 parts by weight of γ alumina powder (average particle diameter: 2 μm) was mixed with 200 parts by weight of water and added with 20 parts by weight of nitric acid to prepare a slurry, and the filter support was soaked in this slurry and taken out, and then extra slurry was removed, and the filter support was dried at 250° C. for 15 minutes. The alumina supporting amount was 120 g/L in terms of the weight per unit volume of the honeycomb filter. Next, a 0.25 mol/L solution of platinum nitrate was prepared. Then, this platinum nitrate solution was absorbed in the filter support so that the platinum supporting amount became 2.0 g/L in terms of the weight of the catalyst for exhaust gas purification per unit volume of the honeycomb filter (4.8 g in terms of the weight of platinum with respect to the honeycomb structure), fired at 600° C. for 1 hour, whereby the honeycomb filter 130 (DPF-C) shown in FIG. 8 was obtained. The porosity of the obtained honeycomb filter 130 (DPF-C) was 60%, and the percentage (unit area ratio) of the total sectional area of the fired materials to the sectional area of the honeycomb filter 130 (DPF-C) was 93.5%.

In the examples 7 and 10, a DPF-C and an NSC-D were used. In the example 7, an NSC-D was disposed at a position of 3 m in length from the engine 20, and a DPF-C was disposed at a position of 3.2 m in length from the engine 20. In the example 10, a DPF-C was disposed a position of 3 m in length from the engine 20, and an NSC-D was disposed at a position of 3 m in length from the engine 20.

### Examples 8 and 11

Next, examples (examples 8 and 11) of exhaust gas cleanup systems 10 using the honeycomb filter 130 and the honeycomb structure 140 are described. In the examples 8 and 11, a DPF-C and an NSC-E were used. In the example 8, an NSC-E was disposed at a position of 3 m in length from the engine 20, and a DPF-C was disposed at a position of 3.2 m in length from the engine 20. In the example 11, a DPF-C was disposed at a position of 3 m in length from the engine 20, and an NSC-E was disposed at a position of 3 m in length from the engine 20.

[Porosity Measurement]

The porosities of DPF-A through C and NSC-D were measured. The porosities were calculated by the following formula (1):
Porosity %=100×(1−G/((V−K)×D)); Formula (1)
upon measuring the dried weight G (g) of the honeycomb filter, the volume V (cm³) of the external form of the honeycomb filter, the volume K (cm³) of the through holes, and the true density D (g/cm³) of the materials forming the honeycomb filter 30.

[Specific Surface Area Measurement]

The specific surface areas of the NSC-D through F were measured. First, the volumes of the porous honeycomb units and the sealing material were actually measured, and the ratio A (volume %) of the materials of the units to the volume of the honeycomb structure was calculated. Next, the BET specific surface area B (m²/g) per unit weight of the porous honeycomb units was measured. The BET specific surface area was measured by the single point method according to JIS-R-1626 (1996) provided in Japanese Industrial Standards by using a BET measurement device (Micromeritics FlowSorb II-2300 made by Shimazu Corporation). The contents of JIS-R-1626 are incorporated by reference herein. For measurement, a sample cut into a columnar small piece (15 mmφ in diameter×15 mm in height) was used. Then, the apparent density C (g/L) of the porous honeycomb units was calculated from the weight and external form volume of the porous honeycomb units, and the specific surface area S (m²/L) of the honeycomb structure was calculated by the following formula (2). The specific surface area of the honeycomb structure mentioned herein means the specific surface area per apparent volume of the honeycomb structure.
S(m²/L)=(A/100)×B×C; Formula (2)

[Exhaust Gas Conversion/Purification Rate Measurement]

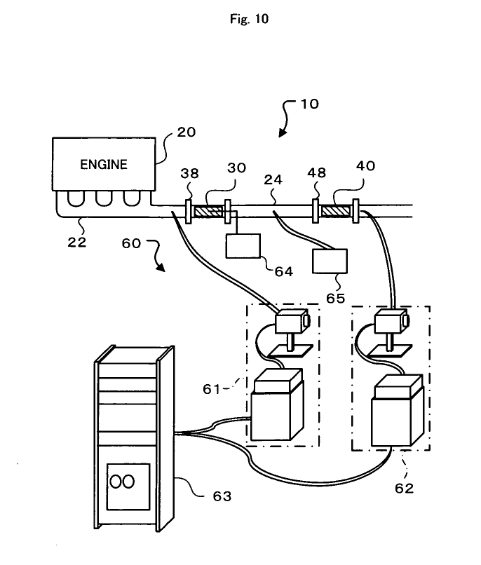

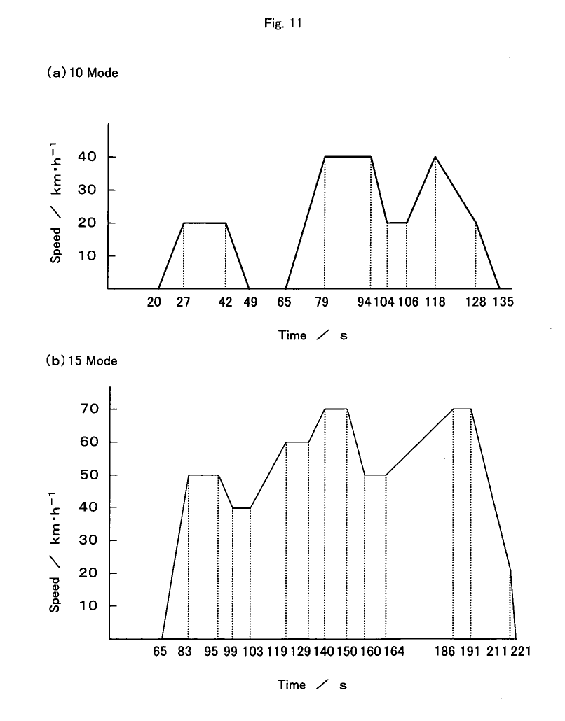

Exhaust gas conversion/purification rates of the examples 1 through 11 were measured. This measurement was made by using the exhaust gas cleanup measuring device 60 shown in FIG. 10. The exhaust gas cleanup measuring device 60 includes an exhaust gas cleanup system 10 including the honeycomb filter 30 and the honeycomb structure 40, a gas sampler 61 that samples an exhaust gas before passing through the honeycomb filter 30, a gas sampler 62 that samples the exhaust gas after passing through the honeycomb structure 40, a gas analyzer 63 that analyzes the concentrations of harmful substances contained in the exhaust gas, a temperature measuring device 64 that measures the temperature of the honeycomb filter 30 by a thermocouple, and a PM counter 65 that measures the amount of PM on the downstream of the honeycomb filter 30. Next, the measuring procedures are described. First, an exhaust gas from the engine 20 was flown through the above-described examples 1 through 11. In this measurement, the engine 20 was driven to perform 3 cycles according to the 10-15 mode exhaust gas measuring method of the diesel-powered automobile shown in FIG. 11. Then, the concentrations of carbon monoxide (CO), hydrocarbon (HC), and nitrogen oxide (NOx) contained in the exhaust gases sampled by the gas samplers 61 and 62 were measured by a gas analyzer 29. The conversion rates were calculated by the following formula (3) by using the concentration C0 contained in the exhaust gas before coming into contact with the DPF and NSC and the concentration Ci contained in the exhaust gas after coming into contact with DPF and NSC. Based on a change in weight of the honeycomb filter between before the measurement and after the measurement, the PM trapping rate was measured. When the PM amount that could not be trapped in the honeycomb filter 30 and exhausted to the downstream was counted from the number of PM particles by using the PM counter 65 (a condensation particle counter 3022A-S made by TSI), the trapping rate (purification rate) was 100% in all examples. The total produced amount of PM produced in this test was investigated in advance, and the result amount was 3.5 g. Therefore, the regenerating rate was calculated from the PM deposit amount with respect to the total produced amount of PM (difference in weight between before the measurement and after the measurement). In addition, when the exhaust gas temperature was checked in advance, it was found that the exhaust gas reached the maximum temperature in a timing of 120 seconds in the 15 mode. Then, the time change in temperature of the honeycomb filter was measured by the temperature measuring device 64, and the time from the point of 120 seconds until the honeycomb filter reached the maximum temperature was calculated.
Conversion rate (%)=(C0−Ci)/C0×100; Formula (3)

[Measuring Results]

The disposition of the DPFs and NSCs, platinum supporting amounts, conversion rates of CO, HC, and NOx, purification rates (PM trapping rates), DPF regenerating rates, the maximum temperatures of DPFs during 10-15 mode measurement, and the times taken until the DPFs reached the maximum temperatures after the exhaust gas reached the maximum temperature of the examples 1 through 11 are shown in Table 2. In the examples 1 through 3, the conversion/purification rates of Co, HC, NOx, and PM were 90% or more and the regenerating rates were also high as 50% or more. The reason for the high regenerating rates is presumed that the catalyst supported in the DPF easily reaches the temperature that makes the catalyst to sufficiently act from the fact that the maximum temperature is high and the time to reach the maximum temperature is short. Particularly, the DPFs of examples 1 and 3 were easily regenerated even though the platinum supporting amounts were small. On the contrary, in the examples 6 through 11, regenerating rates were low as compared to the examples 1 through 3. In the dispositions of NSCs and DPFs of examples 6 through 8 (corresponding to the construction of Patent Document 1), the conversion rates of NO and CO were low. The reason for this is presumed that NO was produced and exhausted when NO₂ burns PM, and PM was imperfectly burned and CO was produced and exhausted. From these results, it was found that by disposing the DPF at a position of an exhaust path length of 1 m or less from the engine 20 and the NSC at a position of an exhaust path length of 3 m or less from the engine 20, PM was easily burned, the honeycomb filter was easily regenerated, and a plurality of harmful substances (CO, HC, NOx, and PM) could be converted and could be purified. Particularly, it was found that among the DPFs, the DPF-A burned PM and was easily regenerated, and in among NSCs, the NSC-D converted harmful substances by a small platinum supporting amount.

The present invention claims priority based on the Japanese Patent Application No. 2004-252889 filed on Aug. 31, 2004, and all contents of the application are incorporated by reference herein the present invention.

What is claimed is:

1. An exhaust gas cleanup system which cleans up an exhaust gas exhausted from an internal combustion engine, comprising:
a first cleanup apparatus that supports a predetermined supporting amount of a first catalyst and purifies particulate materials contained in the exhaust gas; and
a second cleanup apparatus that supports a predetermined supporting amount of a second catalyst and converts the exhaust gas which has passed through the first cleanup apparatus, wherein
the first cleanup apparatus is disposed at a position of an exhaust path length of about 1 m or less from the internal combustion engine.

2. The exhaust gas cleanup system according to claim 1, wherein the first cleanup apparatus has a porosity of about 60% or more.

3. The exhaust gas cleanup system according to claim 1, wherein the first cleanup apparatus is a honeycomb filter formed by laminating, in the longitudinal direction, two or more sheet-like members having a plurality of through holes so that the through holes become communicating holes that communicate with each other.

4. The exhaust gas cleanup system according to claim 3, wherein the honeycomb filter is formed so that communicating holes having one side end faces being clogged and the other side end faces being open and communicating holes having one side end faces being open and the other side end faces being clogged are alternately arranged side by side.

5. The exhaust gas cleanup system according to claim 3, wherein the honeycomb filter is mainly made of one or more materials selected from among inorganic fibers and inorganic foams.

6. The exhaust gas cleanup system according to claim 1, wherein the second cleanup apparatus is disposed at a position of an exhaust path length of about 3 m or less from the internal combustion engine.

7. The exhaust gas cleanup system according to claim 1, wherein the second cleanup apparatus is a honeycomb structure including porous honeycomb units that have a plurality of through holes and a sectional area of about 50 cm² or less of a plane orthogonal to the through holes, and a sealing material layer that joins two or more of the porous honeycomb units on their outer faces with no through holes being open.

8. The exhaust gas cleanup system according to claim 6, wherein the second cleanup apparatus is a honeycomb structure including porous honeycomb units that have a plurality of through holes and a sectional area of about 50 cm² or less of a plane orthogonal to the through holes, and a sealing material layer that joins two or more of the porous honeycomb units on their outer faces with no through holes being open.

9. The exhaust gas cleanup system according to claim 7, wherein in the porous honeycomb unit, a sectional area of a plane orthogonal to the through holes is about 5 cm² or more.

10. The exhaust gas cleanup system according to claim 8, wherein in the porous honeycomb unit, a sectional area of a plane orthogonal to the through holes is about 5 cm² or more.

11. The exhaust gas cleanup system according to claim 7, wherein the percentage of a total sectional area of the porous honeycomb units to a sectional area of the honeycomb structure is about 85% or more.

12. The exhaust gas cleanup system according to claim 8, wherein the percentage of a total sectional area of the porous honeycomb units to a sectional area of the honeycomb structure is about 85% or more.

13. The exhaust gas cleanup system according to claim 7, wherein the porous honeycomb unit is formed to contain at least ceramic particles and inorganic fibers.

14. The exhaust gas cleanup system according to claim 8, wherein the porous honeycomb unit is formed to contain at least ceramic particles and inorganic fibers.

15. The exhaust gas cleanup system according to claim 1, wherein the first catalyst is an oxide having a perovskite structure.

16. The exhaust gas cleanup system according to claim 6, wherein the first catalyst is an oxide having a perovskite structure.

17. The exhaust gas cleanup system according to claim 1, wherein the second catalyst is an oxidation catalyst and an NOx storage agent.

18. The exhaust gas cleanup system according to claim 6, wherein the second catalyst is an oxidation catalyst and an NOx storage agent.

19. The exhaust gas cleanup system according to claim 17, wherein the second catalyst contains one or more kinds selected from a group consisting of precious metals, alkali metals, and alkaline earth metals.

20. The exhaust gas cleanup system according to claim 18, wherein the second catalyst contains one or more kinds selected from a group consisting of precious metals, alkali metals, and alkaline earth metals.
